(19) United States
(12) Patent Application Publication
(10) Pub. No.: US 2006/0200460 A1
(43) Pub. Date: Sep. 7, 2006

(54) System and method for ranking search results using file types

(75) Inventors: Dmitriy Meyerzon, Bellevue, WA (US); Stephen E. Robertson, London (GB); Hugo Zaragoza, Cambridge (GB); Michael J. Taylor, Cambridge (GB)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/073,381

(22) Filed: Mar. 3, 2005

(51) Int. Cl. G06F 17/30

(52) U.S. Cl. 707/5

(57) ABSTRACT

Search results of a search query on a network are ranked according to an additional ranking function for the prior probability of relevance of a document based on document property. The document property may be the document's file type, the file size, the document language, or another query-independent property of the document. The query-independent values for each document property may be weighted according to relevance measurements of the document based on the document property. As more relevance measurements of the documents may be obtained, the query-independent values for each document property may be updated to reflect the new measurements.

### CROSS-REFERENCE TO RELATED APPLICATIONS

The present invention is related to patent applications having Ser. No. 10/955,462, entitled: “System and Method for Incorporating Anchor Text into Ranking Search Results”, filed Sep. 30, 2004; Ser. No. 10/955,983, entitled, “System and Method for Ranking Search Results Using Click Distance”, filed Sep. 30, 2004; Ser. No. 10/804,326, entitled “Field Weighting in Text Document Searching”, filed on Mar. 18, 2004. The related applications are assigned to the assignee of the present patent application and are hereby incorporated by reference.

### BACKGROUND OF THE INVENTION

In a text document search, a user typically enters a query into a search engine. The search engine evaluates the query against a database of indexed documents and returns a ranked list of documents that best satisfy the query. A score, representing a measure of how well the document satisfies the query, is algorithmically generated by the search engine. Commonly-used scoring algorithms rely on splitting the query up into search terms and using statistical information about the occurrence of individual terms in the body of text documents to be searched. The documents are listed in rank order according to their corresponding scores so the user can see the best matching search results at the top of the search results list.

Another evaluation that certain search engines may employ to improve the quality of the results is to modify the rank of the results by a selected ranking function. One exemplary prior art ranking function determines that when one page links to another page, it is effectively casting a vote for the other page. The more votes that are cast for a page, the more important the page. The ranking function can also take into account who cast the vote. The more important the page, the more important their vote. These votes are accumulated and used as a component of the ratings of the pages on the network.

A ranking function is used to improve the quality of the ranking. Typically, when evaluating the performance of a ranking function a set of users are asked to make relevance judgments on the top N (e.g., 10) documents returned by the search engine with a given ranking function for a given set of evaluation queries. The document corpus and the set of queries are kept fixed, so that performance of different ranking functions may be compared side-by-side eliminating all other variables from the equation. This is typically done in a prototyping (research) environment. A set of relevance judgments may also be obtained from a live system by asking users to volunteer relevance judgments for the search results on arbitrary set of queries. Relying on relevance judgments to measure the performance allows a ranking function to be optimized by iteratively varying ranking parameters and measuring performance.

### SUMMARY OF THE INVENTION

Embodiments of the present invention are related to a system and method for ranking search results according to document properties. Inventors of the present invention discovered that independent of the query, the frequency of a document being relevant to any query may depend on a particular document property. For example, the relevance of the file may depend on the type of the file (e.g. word processing document, web page, email message, text file, etc.). In accordance with this discovery, some types of files rank higher than other types of documents despite the query terms used. For example, spreadsheets may be abnormally rare in the set relevant documents with respect to the frequency at which other document types are being returned by the ranking function. The present invention modifies the ranking function with an additional query-independent feature referred to as file type to adjust the ranking of documents based on the type of files, thus improving the overall precision of the search engine. The weight of relevancy associated with each file type is derived from the set of relevance judgments obtained from previous queries and feedback. In addition, by optimizing the weight, the weight may be treated as ranking function parameter, and the behavior of the performance measure on different values of the weight may be observed.

File type is a query-independent relevance measure that is dependent on the type of document returned as a search result. Once the file type is determined for a page, the file type is incorporated into the score for the page. The page's score incorporating the file type determines the page's rank among the other pages within the search results.

Additionally, other document properties may affect the relevance of a document independent of the query. These document properties include the language of the document and the size of the file. Values may be associated with these document properties and incorporated into a scoring function to affect the rank of a document.

In one aspect of the present invention, the network is first “crawled” to generate a table of properties associated with the links and pages of the network. “Crawling” refers to automatically collecting several documents (or any analogous discrete unit of information) into a database referred to as an index. Crawling traverses multiple documents on the network by following document reference links within certain documents, and then processing each document as found. The documents are processed by identifying key words or general text in the documents to create an index.

An exemplary index can be an inverted list that has a column of words and a column indicating in which documents those words can be found. When a user enters in one or more search terms, the results are obtained and the present invention applies a ranking algorithm that includes the file type term. The file type term positively or negatively affects the score of certain pages, refining the results returned to the user.

### BRIEF DESCRIPTION OF THE DRAWINGS

FIG. 1 illustrates an exemplary computing device that may be used in one exemplary embodiment of the present invention.

FIG. 2 illustrates a system for ranking search results according to file types in accordance with the present invention.

FIG. 3 illustrates a functional block diagram of an exemplary system for gathering properties of documents during searching in accordance with the present invention.

FIG. 4 illustrates a logical flow diagram of an exemplary process for using the file type in ranking search results in accordance with the present invention.

### DETAILED DESCRIPTION

The present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

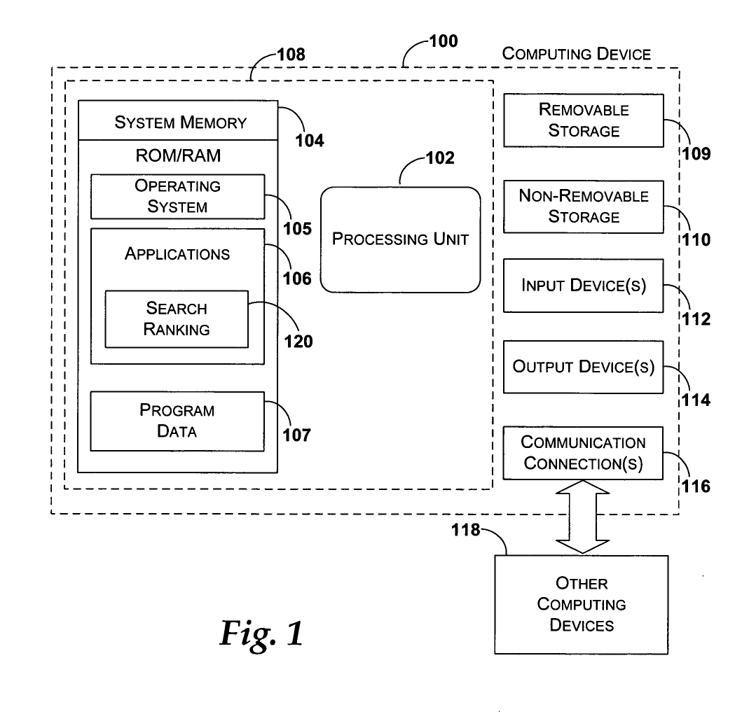

With reference to FIG. 1, one exemplary system for implementing the invention includes a computing device, such as computing device 100. Computing device 100 may be configured as a client, a server, mobile device, or any other computing device. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes a search ranking application 120 for implementing the functionality of the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Illustrative Embodiments for Ranking Search Results Using File Types

Embodiments of the present invention are related to a ranking function for a search engine. The quality of a search engine is typically determined by the relevance of the documents according to the ranks assigned by the ranking function. The ranking function may be based on multiple features. Some of these features may depend on the query, while others are considered query-independent. This invention utilizes a query-independent measure of relevance referred to as file type prior. File type refers most commonly to the file type associated with a document. For example, a document may be a word processing document, a spreadsheet, an HTML web page, or other type of document. The present invention uses the file type of the file as a type-based prior to rank the search results. A prior refers to a prior probability of belief that a document should be relevant given its type. One method for establishing type-base priors is through the use of relevance judgments to weight the file types according to their relevance.

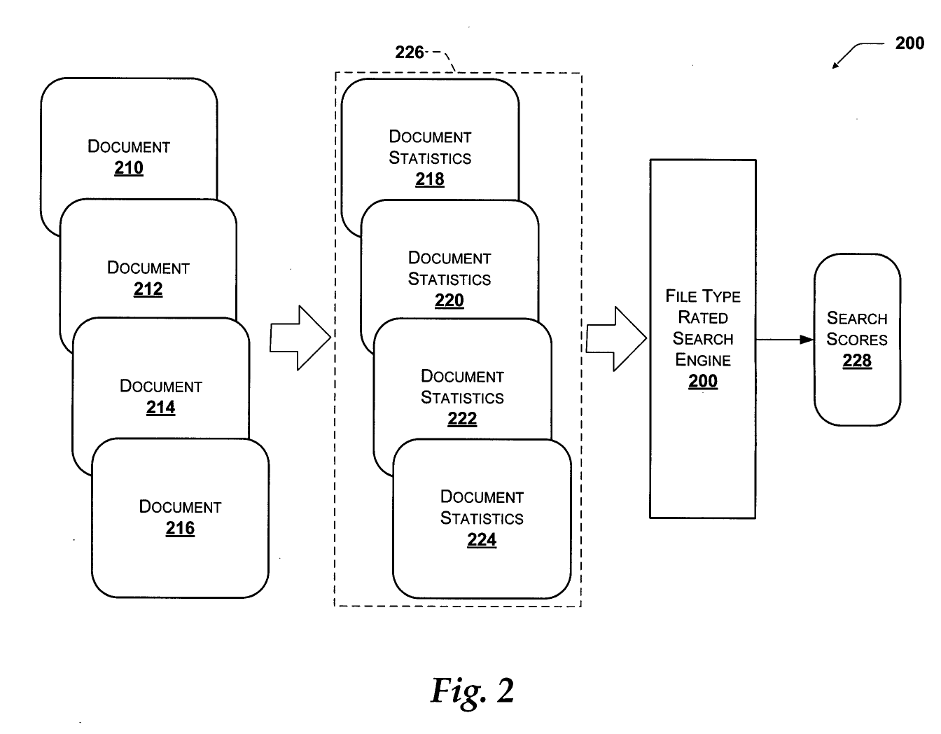

FIG. 2 illustrates a system for ranking search results according to file types in accordance with the present invention. The search engine 200 receives a query containing multiple query terms. Each query term may include multiple component terms, such as when the query term is a phrase (e.g., the phrase “document management system” may be considered a single query term). In addition, a query may include one or more operators, such as Boolean operators, constraints, etc., which are commonly supported by known search engines.

A plurality of documents on a distributed network, represented by documents 210, 212, 214, and 216, are available for searching. In practice, a search engine may search any number of documents and typically search collections containing large numbers (e.g., millions) of documents. The volume of documents may be reduced from the Internet setting to the intranet setting, but the reduction is usually from billions to millions so that the relative number of documents is still quite large. An indexing module (not shown) generates individual document attributes (e.g., file type) and associated statistics (e.g., term frequencies) (218, 220, 222, and 224) for each document. The document attributes and statistics are stored in an index 226.

Search engine 200 consults index 226 to determine a search score 228 for each document based on the query and the corresponding document attributes and statistics. In the present invention, one of the documents attributes included is the file type of the document. The file type is a query-independent attribute that is combined with other query-independent attributes and statistics and query-dependent attributes and statistics to form a document's final score. Typically, document scores 228 are then ranked in descending order to give the user a list of documents that are considered by the search algorithm to be most relevant to the query.

In the illustrated system, the search engine 200 represents a file type rated search engine, which considers the file type of a document in determining the document's search score. File type rating of a document leverages the relevance judgments associated with the each of the file types. A type-based prior is a query-independent relevance measure since it rates the document's importance based on its file type overall rather than according to the query (e.g., a query-dependent ranking function would be counting the number of times a search term appears in a document).

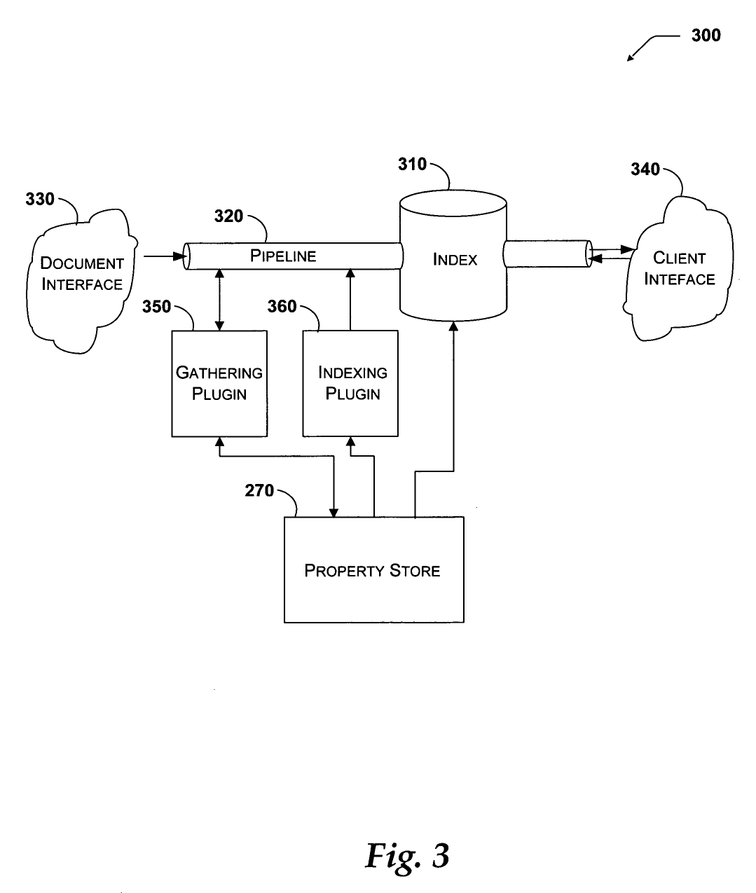

FIG. 3 illustrates a functional block diagram of an exemplary system for gathering properties of documents during searching in accordance with the present invention. System 300 includes index 310, pipeline 320, document interface 330, client interface 340, gathering plugin 350, indexing plugin 360, and property store 270.

Index 310 is includes records that correspond to index keys and other document properties. The records of index 310 are used in providing results to client queries. In one embodiment, index 310 corresponds to multiple databases that collectively provide the storage for the index records.

Pipeline 320 is an illustrative representation of the gathering mechanism for obtaining the documents or records of the documents for indexing. Pipeline 320 allows for filtering of data by various plugins (e.g., gathering plugin 350) before the records corresponding to the data are entered into index 310.

Document interface 330 provides the protocols, network access points, and database access points for retrieving documents across multiple databases and network locations. For example, document interface 330 may provide access to the Internet while also providing access to a database of a local server and access to a database on the current computing device. Other embodiments may access other document locations using a variety of protocols without departing from the spirit or scope of the invention.

Client Interface 340 provides access by a client to define and initiate a search. The search may be defined according to keywords and/or other keys.

Gathering plugin 350 is one of several gatherer pipeline plugins. Gathering plugin 350 identifies properties that are included in a document, such as the text from the title or body, and the file type associated with the document. The properties are gathered by gathering plugin 350 as the documents provided through document interface 330 are crawled. In one embodiment, the functionality of gathering plugin 350 identifies all the fields of a document and their associated properties including the file type of the document.

Indexing plugin 360 is another plugin connected to pipeline 320. Indexing plugin provides the mechanism for generating, partitioning, and updating index 310. In one embodiment, indexing plugin 360 provides the word lists that temporarily cache the keywords and other keys generated from crawled documents before flushing these results to index 310. The records of index 310 are populated from the crawl results included in these word lists.

Property store 370 includes the anchor properties that have been gathered by gathering plugin 350. For a particular document, property store 370 includes a record of the file type that is associated with the document. For example, a record in property store 370 may include a document ID that identifies the document and the file type in separate fields. In other embodiments, other fields may be included in property store 370 that are related to a particular document.

Despite the illustration in system 300 of one-way and two-way communications between functional blocks, any of these communication types may be changed to another type without departing from the spirit or scope of the invention (e.g., all communications may have an acknowledgment message requiring two-way rather than one-way communication).

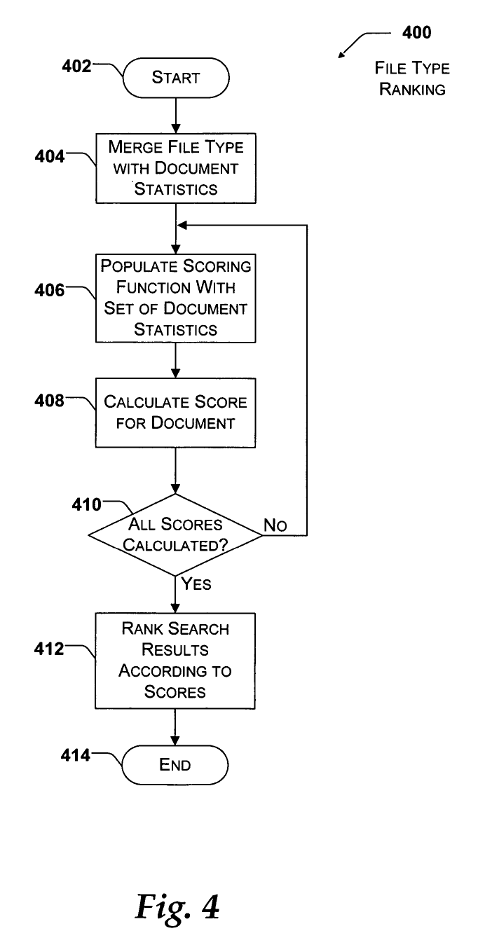

FIG. 4 illustrates a logical flow diagram of an exemplary process for using the file type in ranking search results in accordance with the present invention. Process 400 starts at block 402 where a query has been requested and the query-independent values corresponding to the file types have been calculated. In one embodiment, the file type for each document is recorded within a pseudo-key and stored within the index. A query-independent value may then be obtained by referencing a table of values for each file type. A document of a particular type therefore has a particular query-independent value. For example, when an HTML page is determined as the most relevant type of document independent of a query, HTML pages in the index are associated with the most favorable value (e.g., 1). The other file types are then associated with sequentially less favorable values (e.g., word processing documents—2, spreadsheets—3, etc.) These values may be weighted according to the associative relevance of each file type. Additionally, the file type values belong to a finite set. This makes the file type prior a discrete function with relatively small number of different values (e.g., there may only be 6 recognized file types). With the discrete number of values it possible to estimate each value of the function completely from relevance judgments, or by treating each value as a separate parameter of the ranking function and finding the best (for each file type) value by tuning (see discussion below). In contrast, other query independent (e.g., click distance are not mapped to a small set of distinct values, so the ranking formula and tuning functionality is significantly different. With the query received and the file type values calculated, processing continues at block 404.

At block 404, the weighted file type value for each of the documents is merged with the other document statistics (see FIG. 2) in the index. Merging the file type values with the other document statistics allows for a faster query response time since all the information related to ranking is clustered together. Additionally, query-independent values based on other document properties, such as click distance of the document from a parent document, may be added to obtain a combined query-independent value for each document. Accordingly, each document listed in the index has an associated combined-query independent value. Click distance is further described in patent application Ser. No. 10/955,983, entitled “System and Method for Ranking Search Results Using Click Distance”, filed on Sep. 30, 2004 and hereby incorporated by reference. Once the merge is complete, processing moves to block 406.

At block 406, a scoring function is populated with the set of document statistics, including the component corresponding to the prior probability of relevance based on the file type. The scoring function calculates a score for a particular document. The file type component provides a query-independent factor to the scoring function. The other portion of the scoring function corresponds to other query-independent factors and the query-dependent or content-related portion of the scoring function. In one embodiment, the scoring function is a sum of query-dependent (QD) and query-independent (QID) scoring functions:
Score=QD(doc,query)+QID(doc) (1)

The QD function can be any document scoring function. In one embodiment, the QD scoring function corresponds to the field weighted scoring function described in patent application Ser. No. 10/804,326, entitled “Field Weighting in Text Document Searching”, filed on Mar. 18, 2004 and hereby incorporated by reference. As provided by the Ser. No. 10/804,326 patent application the following is a representation of the field weighted scoring function:

$$QD ( doc , query ) = \sum \frac{wtf ( {k}_{1} + 1 )}{{k}_{1} ( ( 1 - b ) + b \frac{w ⅆ l}{avw ⅆ l} ) + wtf} \times log ( \frac{N}{n} ) \qquad ( 2 )$$

Wherein the terms are defined as follows: wtf is the weighted term frequency or sum of term frequencies of a given terms multiplied by weights across all properties; wdl is the weighted document length; avwdl is the average weighted document length; N is the number of documents on the network (i.e., the number of documents crawled); n is the number of documents containing the given query term; and k₁ and b are constants. These terms and the equation above are described in detail in the Ser. No. 10/804,326 patent application.

The QID function can be any transformation of document properties or statistics such as the file type component, click-distance, and other document statistics (such as URL depth). In one embodiment this function for click distance and URL depth is as follows:

$$QID ( doc ) = \sum {w}_{cd} \frac{{k}_{c d}}{{k}_{c d} + \frac{{b}_{c d} CD + {b}_{ud} UD}{{b}_{c d} + {b}_{ud}}} \qquad ( 3 )$$

Wherein the terms for the function are defined as follows: w_{cd} is the weight of the query-independent component; b_{cd} is the weight of the click distance; b_{ud} is the weight of the URL depth; CD is the Click Distance; UD is the URL Depth; and k_{cd} is the click distance saturation constant. The weighted terms (w_{cd}, b_{cd}, and b_{ud}) assist in defining the importance of each of their related terms and ultimately the shape of the scoring functions. The URL depth (UD) is an addition to the query-independent component to smooth the effect of the click distance on the scoring function. In some cases, a document that is not very important (i.e., has a large URL depth) may have a short click distance. For this embodiment, the present invention adds the two functions of (2) and (3) and the file type component (W(t)) to receive the scoring function (Score), such that the new scoring function becomes:

$$\begin{matrix}Score = \sum \frac{wtf ( {k}_{1} + 1 )}{{k}_{1} ( ( 1 - b ) + b \frac{w ⅆ l}{avw ⅆ l} ) + wtf} \times log ( \frac{N}{n} ) \\ {w}_{c d} \frac{{k}_{c d}}{{k}_{c d} + \frac{{b}_{c d} CD + {b}_{ud} UD}{{b}_{c d} + {b}_{ud}}} + W ( t )\end{matrix} \qquad ( 4 )$$

In other embodiments, the query-independent component may be incorporated into other ranking functions not shown for improvement of the ranking results without departing from the spirit or scope of the invention. Once scoring function (4) is populated with the document statistics for a particular document, processing proceeds to block 408.

At block 408, the scoring function is executed and the relevance score for the document is calculated. Once the relevance score is calculated, it is stored in memory and associated with that particular document. Processing then moves to decision block 410.

At decision block 410, a determination is made whether relevance scores for all the documents corresponding to the search query have been calculated according to scoring function (4). The scores may be calculated serially as shown or in parallel. If all the scores have not been calculated, processing returns to block 406 where the scoring function is populated with the next set of document statistics. However, if the all the scores have been calculated, processing continues to block 412.

At block 412, the search results of the query are ranked according to their associated scores. The scores now take into account the file type of each of the documents. Accordingly, the ranking of the documents has been refined so that documents of a particular document type are ranked higher the other documents of different file types where all other factors are the same. Once the search results are ranked, processing proceeds to block 414, where process 400 ends.

After process 400 is complete, the ranked documents may be returned to the user by the various operations associated with the transmission and display of results by a search engine. The documents corresponding to the higher precision results may then be selected and viewed at the user' discretion.

In one embodiment, the value associated with each file type is dependent upon previous relevance judgments made for each of the file types. For example, it may be determined that HTML documents are the most relevant documents independent of other factors. Accordingly, the HTML documents are accorded a higher score than the other documents. Furthermore, the scores may be normalized so that the values associated with other file types are measured according to their difference from the most relevant file type. Furthermore, additional relevance judgments may be made for the documents based on their file types so that the values associated with each file type are effectively “tuned” to achieve additional accuracy in the results.

Despite the concentration of the above discussion on file types, document properties other than the file type may be used according to the scoring function above to rank the search results. For example, a value may be associated with languages of documents, so that certain languages are valued as more relevant than other languages. Providing a factor in the scoring function to represent a value for the various languages further refines the ranking of the search results. In another example, a value may be associated with a range of sizes for each file associated with each document. For example, files between 0 and 100 KB may have one weighted value, while another weighted value is assigned to files greater than 10 MB. Assigning the weighted value to ranges of file sizes keeps the number of values discrete so that relevance measures and tuning may be applied. With the associated file size values, another factor may then be added to the scoring function to represent a value associated with the file size, such that files within a first size range are scored as more relevant than files within another size range.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for ranking search results, comprising:
detecting a first property associated with each document in a collection of documents; wherein the first property is a file type associated with the document;
storing the first property of each document in an index;
estimating a query-independent value corresponding to the first property for each document, wherein the query-independent value corresponds to a measure of the relevance of each document based on the first property; and
ranking each document that is responsive to a search query to obtain the search results, wherein each document is ranked based on the query-independent value.

2. The computer-implemented method of claim 1, further comprising detecting a second property associated with each document, wherein the second property corresponds to at least one of a file size range and a document language.

3. The computer-implemented method of claim 1, further comprising combining the query-independent value associated with the first property with another query-independent value associated with a second property to obtain a combined query-independent value for each document.

4. The computer-implemented method of claim 3, further comprising storing the combined query-independent value in the index for each of the documents while awaiting a search query.

5. The computer-implemented method of claim 3, further comprising combining at least one query-dependent value with the combined query-independent value to produce a score for each document, wherein each document is ranked according to the score for each document.

6. The computer-implemented method of claim 1, wherein the query-independent value for each file type is generated from relevance judgments made regarding the file types, such that each file type is weighted against the other file types.

7. The computer-implemented method of claim 1, further comprising adjusting the query-independent value for each document, as additional search queries are performed and a relevance measure of the search results based on the file types is made.

8. The computer-implemented method of claim 1, wherein ranking each document based on the query-independent value further comprises using a component corresponding to the first property in a scoring function for determining a relevance score for each of the documents.

9. The computer-implemented method of claim 1, wherein the first property for a document is stored within a pseudo-key that associates the first property with the document in the index.

10. The computer-implemented method of claim 1, further comprising ranking the documents according to a scoring function (score) that is determined according to at least: the first property (W(t)).

11. The computer-implemented method of claim 10, wherein the scoring function (score) is further determined according to: a computed click distance (CD), a weight of a query-independent component (w_{cd}), a weight of the click distance (b_{cd}), a weight of a URL depth (b_{ud}), the URL depth (UD), and a click distance saturation constant (K_{cd}).

12. The computer-implemented method of claim 11, wherein the scoring function (score) is further determined according to: a weighted term frequency (wtf), a weighted document length (wdl), an average weighted document length (avwdl), a number of documents on the network (N); a number of documents containing a query term (n), and other constants (k₁, b).

13. The computer-implemented method of claim 12, wherein the scoring function (score) is given by:
$$\begin{matrix}score = \sum \frac{wtf ( {k}_{1} + 1 )}{{k}_{1} ( ( 1 - b ) + b \frac{w ⅆ l}{avw ⅆ l} ) + wtf} \times log ( \frac{N}{n} ) + \\ {w}_{c d} \frac{{k}_{c d}}{{k}_{c d} + \frac{{b}_{c d} CD + {b}_{ud} UD}{{b}_{c d} + {b}_{ud}}} + W ( t )\end{matrix}$$

14. A system for ranking search results, comprising:
a search engine include on a computing device, the search engine configured to execute computer-executable instructions, the computer-executable instructions comprising:
detecting a first property associated with each document in a collection of documents, wherein the first property corresponds to at least one of a file type, a file size range, and a document language;
storing the first property of each document in an index;
estimating a query-independent value corresponding to the first property for each document, wherein the query-independent value corresponds to a measure of the relevance of each document based on the first property; and
ranking each document that is responsive to a search query to obtain the search results, wherein each document is ranked based on the query-independent value.

15. The system of claim 14, wherein the computer-executable instructions further comprise ranking the documents according to a scoring function (score) that is determined according to at least: the first property (W(t)).

16. The system of claim 15, wherein the scoring function (score) is further determined according to: a computed click distance (CD), a weight of a query-independent component (w_{cd}), a weight of the click distance (b_{cd}), a weight of a URL depth (b_{ud}), the URL depth (UD), a click distance saturation constant (K_{cd}), a weighted term frequency (wtf), a weighted document length (wdl), an average weighted document length (avwdl), a number of documents on the network (N); a number of documents containing a query term (n), and other constants (k₁, b), and the scoring function (score) is given by:
$$\begin{matrix}score = \sum \frac{wtf ( {k}_{1} + 1 )}{{k}_{1} ( ( 1 - b ) + b \frac{ w ⅆ l}{avw ⅆ l} ) + wtf} \times log ( \frac{N}{n} ) + \\ {w}_{c d} \frac{{k}_{c d}}{{k}_{c d} + \frac{{b}_{c d} CD + {b}_{ud} UD}{{b}_{c d} + {b}_{ud}}} + W ( t )\end{matrix}$$

17. A computer-readable medium that includes computer-executable instructions for ranking search results, the computer-executable instructions comprising:
storing a first property of each document in an index, wherein the first property corresponds to a file type;
estimating a query-independent value corresponding to the first property for each document, wherein the query-independent value corresponds to a measure of the relevance of each document based on the first property;
combining the query-independent value associated with the first property with another query-independent value associated with a second property to obtain a combined query-independent value for each document;
storing the combined query-independent value in the index for each of the documents while awaiting a search query; and
ranking each document that is responsive to a search query to obtain the search results, wherein each document is ranked based on the combined query-independent value.

18. The computer-readable medium of claim 17, further comprising combining at least one query-dependent value with the combined query-independent value to produce a score for each document, wherein each document is ranked according to the score for each document.

19. The computer-readable medium of claim 17, wherein the query-independent value for each file type is generated from relevance judgments made regarding the file types, such that each file type is weighted against the other file types.

20. The computer-readable medium of claim 17, further comprising adjusting the query-independent value for each document, as additional search queries are performed and a relevance measure of the search results based on the file types is made.
